(19) United States
(12) Patent Application Publication
(10) Pub. No.: US 2026/0084930 A1
(43) Pub. Date: Mar. 26, 2026

(54) RESCUE SYSTEM, ELEVATOR, AND METHOD OF RESCUING ELEVATOR PASSENGERS

(71) Applicant: Kone Corporation, Helsinki (FI)

(72) Inventors: Matti RÄSÄNEN, Helsinki (FI); Tapani Talonen, Helsinki (FI); Ari Kattainen, Helsinki (FI); Markku Haapaniemi, Helsinki (FI); Ville Myyryläinen, Helsinki (FI); Lasse Nyman, Helsinki (FI); Mika Ijäs, Helsinki (FI); Mikko Kukkola, Helsinki (FI); Jouni Lappalainen, Helsinki (FI); Jari Kantola, Helsinki (FI); Tarvo Viita-Aho, Helsinki (FI)

(73) Assignee: Kone Corporation, Helsinki (FI)

(21) Appl. No.: 19/404,457

(22) Filed: Dec. 1, 2025

Related U.S. Application Data
(63) Continuation of application No. PCT/EP2023/064839, filed on Jun. 2, 2023.

(51) Int. Cl. B66B 5/02

(52) U.S. Cl. CPC B66B 5/027

(57) ABSTRACT

A rescue system, an elevator, and a method for moving an elevator car vertically inside a shaft of the elevator in a rescue operation. The system comprises a rescue rope connectable to an elevator car and being a separate element relative to a suspension rope of the elevator car. A pulling device is connectable to the rescue rope and is used for generating pulling force which is for directing moving force to the elevator car. The rescue rope passes via diverting pulleys mounted at a top and a bottom parts of the shaft. Then the rescue rope forms a loop configuration inside which the diverting pulleys are located.

### CROSS-REFERENCE TO RELATED APPLICATIONS

This application is a continuation of PCT International Application No. PCT/EP2023/064839 which has an International filing date of Jun. 2, 2023, the entire contents of which are incorporated herein by reference.

### BACKGROUND OF THE INVENTION

The invention relates to a rescue system of an elevator.

The invention further relates to an elevator, and to a method for rescuing passengers of an elevator.

The field of the invention is defined more specifically in the preambles of the independent claims.

An elevator comprises an elevator car which is moved vertically in an elevator shaft and is stopped at landings. In case of different fault situations, the elevator car may be stopped at positions not matching with the landings and thereby causing trapping of passengers inside the elevator car. Rescuing of the passengers trapped in the elevator must be possible also in situations when power supply of the elevator is broken, and the elevator is in fault mode. Different rescue systems utilizing a rescue rope and a separate pulling device have been developed. However, the known rescue systems have shown some difficulties.

### BRIEF DESCRIPTION OF THE INVENTION

An object of the invention is to provide a novel and improved rescue system and an elevator provided with such system. A further object is to provide a new and improved method for rescuing passengers from an elevator car.

The rescue system according to the invention is characterized by the characterizing features of the first independent apparatus claim.

The elevator according to the invention is characterized by the characterizing features of the second independent apparatus claim.

The method according to the invention is characterized by the characterizing features of the independent method claim.

An idea of the disclosed solution is to provide a system for evacuation in an elevator wherein unauthorized access to the shaft through landing doors is prevented by limiting possibility to open the landing doors.

The disclosed rescue system comprises a rescue rope connectable to an elevator car and being a separate element relative to a suspension rope of the elevator car. A pulling device is provided for generating pulling force. The pulling device is connectable removably to the rescue rope for directing moving force to the elevator car by means of the rescue rope. Further, the rescue system comprises one or more first diverting pulleys mounted at a top part of the shaft and one or more second diverting pulleys mounted at a bottom part of the shaft. Then the rescue rope is conveyed via the mentioned first and second diverting pulleys thereby forming a loop configuration inside which the first and second diverting pulleys are located.

The disclosed solution provides an additional roping system which is separate from a normal elevator operation mechanism and is only for the passenger rescue. In some cases the rescue system may also be utilized in some maintenance operations.

The disclosed solution provides a manual rescue method and system suitable especially for no-pit/low pit and/or no head room elevator concepts since no entry into the elevator shaft is needed. The access to the shaft through landing doors is prevented in order to prevent any access to the shaft, because there is no natural safety space in the pit or in the headroom of the shaft.

When the rescue rope is supported to the diverting pulleys at a top and bottom of the shaft, the rescue rope is well reachable at any position between the top and bottom part of the shaft.

According to an embodiment, one end of the rescue rope is connected to a top part of the elevator car and a second end of the rescue rope is connected to a bottom part of the elevator car. In other words, the rescue rope is fixedly connected to the elevator car and is moving when the elevator car moves during the normal operation of the elevator. Thus, in this embodiment, the rescue rope is connected to the elevator car and moves together with the vertical movements of the elevator car.

According to an embodiment, the rescue rope is selectively connectable to the elevator car. In other words, the rescue rope is arranged to pass the elevator car and the elevator car is selectively connectable to the passing rescue rope. An advantage of this solution is that the rescue rope is connected to the elevator car only when rescuing passengers or executing maintenance operations. Then the rescue rope does not move when the elevator car is moved during the normal operation of the elevator.

According to an embodiment, the rescue rope is configured to form an endless loop.

According to an embodiment, the rescue rope is immovable in normal operation of the elevator and the elevator car is connected selectively to the rescue rope only for the duration of the rescue operation. In other words, the rescue rope moves around the diverting pulleys only when the power device is connected to move the rescue rope and the rescue rope is connected to the elevator car. An advantage of this embodiment is that the rescue rope and the diverting pulleys do not wear during the normal elevator operation and thereby they do not need any periodical service. Then service costs are low.

According to an embodiment, the elevator car is provided with a gripper and the rescue rope is provided with a counterpart. Then the gripper is selectively lockable and unlockable to the counterpart for coupling the rescue rope and the elevator car together.

According to an embodiment, both free ends of the rescue rope are mounted to the counterpart, which connects the rescue rope ends and forms thereby a loop-like configuration.

According to an embodiment, the gripper and the counterpart are configured to provide a shape locking between the elevator car and the counterpart when the gripper is activated.

According to an embodiment, the counterpart comprises an extension element provided with a locking groove for receiving a locking element of the gripper.

According to an embodiment, the counterpart comprises cone shaped guiding surfaces on its upper and lower parts and tapering away from a middle part of the counterpart. The counterpart may have a shape of a round ball, or an elliptical ball.

According to an embodiment, the gripper is a remotely controlled device whereby it is switchable between a connecting mode and an idle mode.

According to an embodiment, the gripper can be controlled under control of a control system located inside a control cabinet intended for service and rescue purposes and being located typically at a lowermost or uppermost landing.

According to an embodiment, the gripper may comprise one or more electrically operable actuators for executing the locking and unlocking. The gripper is an electrically controllable device.

According to an embodiment, the gripper is a mechanically operable locking mechanism made of metal or equally strong material.

According to an embodiment, the gripper is a manually operable device. Then the gripper can be switchable between a connecting mode and an idle mode manually from inside the elevator car, for example.

According to an embodiment, the gripper may comprises one or more gripping jaws which can open against a spring force when a counterpart is pulled towards them, and the one or more locking jaws can lock by means of the spring force to a determined locking groove or corresponding locking shape or surface of the counterpart. Thus, the locking operation can be mechanically controlled. The one or more locking jaws can be released either mechanically against the spring force, or alternatively, there may be an actuator, a remotely operable device, or an element by means of which the locking can be controllably released.

According to an embodiment, the gripper is attached to a side of the elevator car structures, or to upright beams of the elevator car in a free space between a wall of the elevator car and a wall of the shaft. Alternatively, the gripper can also be attached to the counterweight frame when the rescue rope is routed via the elevator car to the counterweight arrangement.

According to an alternative embodiment, the gripper comprises a remotely controllable clamp or corresponding force element configured to press against the rescue rope and produce sufficient friction forces for transmission of forces moving the elevator car.

According to an embodiment, the rescue rope passes the elevator car in a space between inner side surfaces of the shaft and outer sides surfaces of the elevator car.

According to an embodiment, the rescue rope passes the elevator car in a door sill space.

According to an embodiment, the rescue rope is arranged to be reachable through an emergency opening at a top and bottom landing doors. Landing door emergency opening is restricted to max 200 mm gap so that no entering to the shaft is possible. Then a ratchet hoist or other pulling device can be clamped to the rescue rope through the limited gap opening of the doors. An opposite end of the pulling device is anchored to a landing floor, for example. When the elevator is provided with high friction suspension ropes, then there may be a need to use simultaneously with the winching rescue brake opening buttons to able the movement of the elevator car. In other words, a rescue rope loop is made available at the narrow opening of a landing door. The movement of the door may be restricted to 200 mm by a door restrictor element, for example.

According to an embodiment, the separate pulling device is a pulling winch. In other words, the pulling device is a separate pulling device in relation to the basic structure of the elevator and is mounted in place only for the duration of the rescue operation. An advantage of the pulling winch is that it is simple, reliable, and lightweight device for providing the needed pulling forces in special situations.

According to an embodiment, the pulling device may be a cable pulling winch, a rope pulling winch, a belt pulling winch, a chain block, an electric winch, or an angular gear.

According to an embodiment, the pulling device is mountable to the rescue rope by means of connecting element wherein the connection between the power device and the rescue rope is based on friction forces.

According to an embodiment, the connecting element is a clamp which is configured to direct compression stress to outer surface of the rescue rope and to thereby produce friction forces.

According to an embodiment, the pulling device is mountable to a surface of a landing.

According to an embodiment, the pulling device is mountable to a door sill structure.

According to an embodiment, the mounting of the pulling device to fixed structures may comprise loop screws which are easy and quick to mount removably.

According to an embodiment, the pulling device is mountable to bottom floor of the elevator shaft or to a fixed structure mounted to the bottom of the elevator shaft.

According to an embodiment, the rescue rope is a rope, chain, or belt made of metal, such as steel, or polymeric materials or composite materials. In general, the rescue rope is a bendable transmission element capable to transmit moving forces generated by the pulling device to the elevator car in the rescue operation.

According to an embodiment, the rescue system is provided with at least one safety switch mounted in connection with a control system of the rescue system and is configured to switch of electrical circuit of a drive system of the elevator in response to activation of the rescue control system. In other words, the rescue system is provided with one or more safety switches for switching off normal operation of the elevator system. Then safety of the person executing rescue operation using a rescue rope is ensured and any normal operation of the elevator is prevented when the connection between the car and the rescue equipment is locked. The safety switch is mounted so that it is easy and quick to use.

According to an embodiment, the safety switch is located at the rescue panel door or rescue equipment. The rescue panel may be located at the bottom floor landing, for example. Then there is need to use maintenance switches which are typically located at the maintenance access panel at the top floor landing.

According to an embodiment, the disclosed solution relates also to an elevator comprising: an elevator shaft; an elevator car supported vertically movably inside the elevator shaft; a hoisting machinery and suspension elements for moving and supporting the elevator car; several landings; at least one control unit for controlling operation of the elevator; and a rescue system provided with a rescue rope connectable to an elevator car and being a separate element relative to a suspension rope of the elevator car whereby a pulling device generating pulling force is connectable removably to the rescue rope for directing moving force to the elevator car by means of the rescue rope. Further, the rescue system is in accordance with the features and embodiment disclosed in this document and comprises one or more first diverting pulleys mounted at a top part of the shaft and one or more second diverting pulleys mounted at a bottom part of the shaft. The rescue rope is conveyed via the mentioned first and second diverting pulleys thereby forming a loop configuration inside which the first and second diverting pulleys are located.

According to an embodiment, the elevator is provided with a rescue moving system for moving the elevator car from outside the elevator shaft without entering to the pit. In other words, the elevator car is movable forcedly by the rescue moving system in situations when the elevator is without electricity. The elevator car can be moved without a need to have an access on top of the elevator car or to the pit. The solution provides a safe and handy arrangement for performing rescue and entrapment in fault situations.

According to an embodiment, depth of a pit below a lowermost landing is 500 mm or less.

According to an embodiment, the elevator is without a machine room at a top part of the shaft. Then the elevator is a so called no head room elevator.

According to an embodiment, the disclosed rescue system may, in some cases, also be utilized in elevators wherein shafts are provided with sufficient vertical safe spaces at their top and bottom parts.

According to an embodiment, the disclosed solution relates also to a method for moving an elevator car vertically inside an elevator shaft of the elevator in a rescue operation wherein passengers are rescued out of the elevator car. The method comprises: connecting a separate pulling device removably to a rescue rope coupled to the elevator car and directing generated pulling force to the elevator car by means of the rescue rope and the pulling device during the rescue operation for moving the elevator car in downward direction towards a landing being nearest to a current vertical position of the elevator car. The method further comprises conveying the rescue rope via diverting pulleys mounted to structures of the elevator shaft and directing the pulling force to the elevator car by moving the rescue rope via the diverting pulleys by means of the pulling device.

In other words, the method implements the rescue rope which is a separate element relative to basic suspension ropes of the elevator car and which rescue rope is directed to pass via the diverting pulleys at a top and bottom parts of the elevator shaft. Then the rescue rope is easy to be reached and coupling of the pulling device to the rescue rope is easy and safe.

The method can be implemented in elevators wherein there in no pit or a pit with limited depth, wherefore entering of rescue personnel and maintenance technicians to the pit is prevented. The same applies also for situations when the elevator is of no-head-room type and is without any safe space at vertical upper part of the shaft. Then entering on top part of the elevator car can also be prevented.

According to an embodiment, the method further comprises allowing the elevator car to move freely in relation to the rescue rope during the normal operation of the elevator and coupling the rescue rope remotely to the elevator car only for the duration of the rescue operation.

According to an embodiment, the method further comprises connecting the pulling device between the rescue rope and a structure of a floor of a landing.

According to an embodiment, the method further comprises opening a rescue door of the elevator shaft only partly and connecting the pulling device to the rescue rope through a narrow gap formed by the opening of the rescue door.

According to an embodiment, the method further comprises connecting the elevator out of a normal operation mode to a rescue mode prior initiating moving measures of the rescue operation, whereby normal drive mechanism of the elevator is switched out in the selected rescue mode.

The above disclosed embodiments may be combined to form suitable solutions having those of the above features that are needed.

### BRIEF DESCRIPTION OF THE FIGURES

Some embodiments are described in more detail in the accompanying drawings, in which

FIG. 1 is a schematic and highly simplified side view of a traction elevator,

FIG. 2 is a schematic diagram of basic features of a rescue system,

FIG. 3 is a schematic side view of a rescue system comprising a rescue rope connected to an elevator car,

FIG. 4 is a schematic side view of a rescue door being slightly opened for allowing coupling a clamping device to a rescue rope,

FIG. 5 is a schematic side view of a rescue system in an idle mode and FIG. 6 shows the same system in an operational mode,

FIG. 7 is a schematic view of a counterpart mounted to a rescue rope,

FIG. 8 is a schematic view of a gripper mounted to an elevator car, and

FIG. 9 is a schematic view showing coupling between the gripper and the counterpart.

For the sake of clarity, the figures show some embodiments of the disclosed solution in a simplified manner. In the figures, like reference numerals identify like elements.

### DETAILED DESCRIPTION OF SOME EMBODIMENTS

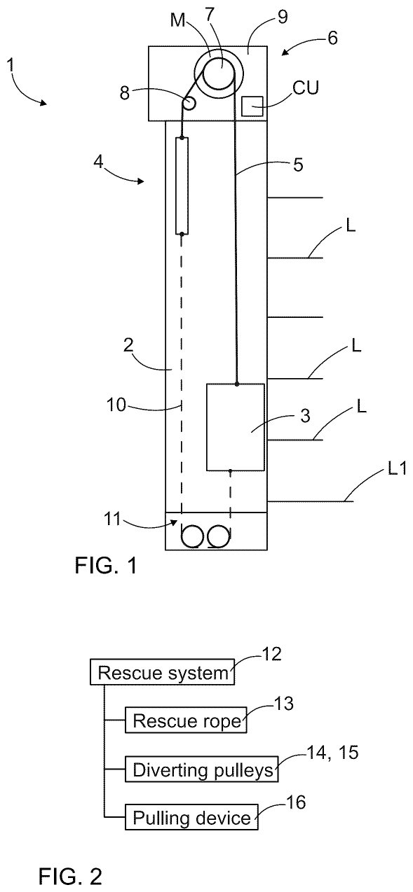

FIG. 1 discloses a traction elevator 1 mounted to an elevator shaft 2 of a building. The elevator 1 comprises an elevator car 3 for receiving load and passengers to be transported. The car 3 and a counterweight assembly 4 are suspended from a suspension rope 5 passing via a hoisting machinery 6. The hoisting machinery 6 comprises a traction sheave 7 driven by means of an electric motor M. Between the suspension rope 5 and the traction sheave 7 occurs friction which is utilized for transmitting lifting power to the elevator system. The hoisting machinery 6 may comprise one or more additional pulleys 8 for guiding and controlling the suspension rope 5. The hoisting machinery 6 may be located at an upper machine room 9, or alternatively the system may be a so called machine room less elevator. A compensation chain or rope 10 may, or may not, be connected between the counterweight assembly 4 and a bottom of the elevator car 3.

The elevator car 3 can be driven to desired landings L or floors under control of one or more control units CU. Below a first or lowermost landing L1 there may be a pit 11 of the shaft 2.

There is a desire to decrease depths of the pits 11 since deep pits cause several problems to building structure and cause expenses for builders. However, reduced depth of the pit 11 needs to be considered by elevator manufactures since safety regulations require that risk of crushing must be prevented in situations when the elevator car is moved to its lowermost position. The low or no pit structures, as well as low or no head rooms, cause problems to rescue operations and a serious risk of the crushing.

It should be noted that the type and operating principle of the elevator 1 may be different from the one shown in FIG. 1 and still the disclosed rescue system can be utilized.

FIG. 2 discloses that a rescue system 12 comprises a rescue rope 13 which is conveyed through diverting pulleys 14, 15. A separate pulling device 16, or force device can be connected to the rescue rope 13 for moving the elevator car towards a closest or desired landing.

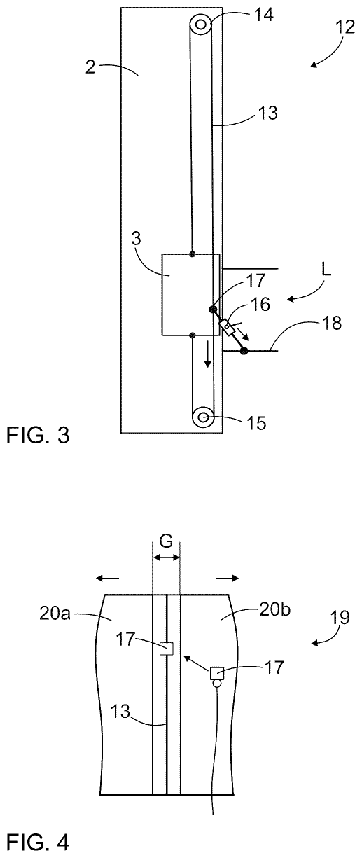

In FIGS. 3,5 and 6 basic driving mechanisms of the elevator are not disclosed for clarity reasons.

FIG. 3 discloses a rescue system 12 wherein a rescue rope 13 is driven via a first diverting pulley 14 supported at a top part of a shaft 3 and via a second diverting pulley 15 supported at a bottom part of the shaft 3. The rescue rope 13 is mounted to an elevator car 3. In a rescue operation a separate pulling device 16 can be connected to the rescue rope 13 and pulling force can thereby directed to the elevator car 3 via the rescue rope 13. Thereby the elevator car 3 can be pulled to a landing L and passengers trapped inside the elevator car 3 can exit safely. The pulling device 16 can be connected removably to the rescue rope 13 by means of a coupling device 17, such as a clamp, and an opposite end of the pulling device 16 can be anchored to a floor surface 18 of the landing L, for example.

FIG. 4 discloses a solution wherein a door system 19 of an emergency opening are opened in a rescue situation so that a gap G with limited size is formed between door panels 20a, 20b thereby exposing a rescue rope 13. This way it is possible to mount a coupling device 17 to the rescue rope and form a pulling force transfer system between the rescue rope and the pulling device. The gap G is dimensioned so that no entrance through it is possible to a shaft.

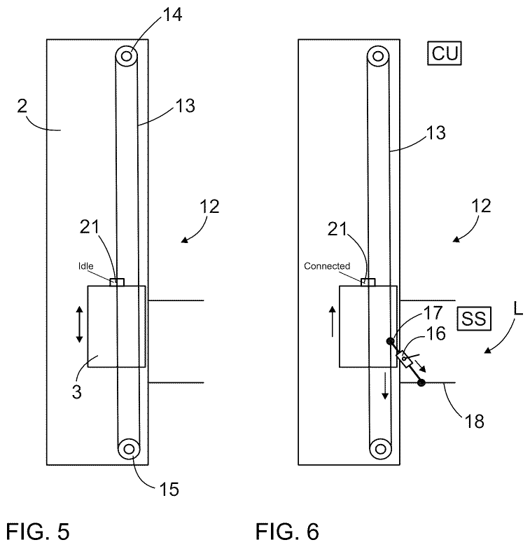

FIG. 5 discloses another type of a rescue system 12 which differs from the one shown in FIG. 4 in that a recure rope 13 is not fixedly mounted to an elevator car 3 by passes it freely. Then the rescue rope remains immovable when the elevator car 3 moves during normal operation. There is a gripper 21 in connection with the elevator car 3 for providing selective coupling between the rescue rope 13 and the elevator car 3. In FIG. 5 the gripper 21 is an idle mode and no force transmission occurs through it. In FIG. 6 the gripper 21 is activated and the gripper 21 is connected to the rescue rope 13 whereby forces generated by a pulling device 16 can be directed by means of the rescue rope 13 to the elevator car 13.

FIG. 6 further discloses a safety switch SS by means of which control commands can be given to a control unit CU for preventing operation of the elevator for the duration of the rescue operation. The safety switch SS may alternatively be configured to switch of operating electrical circuit and thereby prevent the normal operation of the elevator.

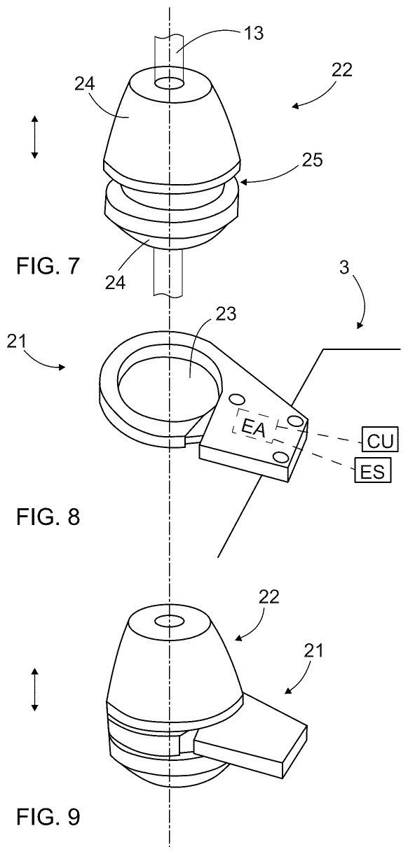

FIG. 7-9 disclose one embodiment of a selectable connectable coupling arrangement comprising a gripper 21 mounted to an elevator car 3 and a counterpart 22 mounted fixedly to a rescue rope 13. The gripper 21 comprises an opening 23 through which the counterpart 22 can pass when the gripper 21 is in idle mode. The gripper 21 can be connected so that it can grip the counterpart 22 and transmit forces between them. The counterpart 22 may comprise conical guide surfaces 24 and a locking groove 25. The gripper 21 can form a shape locking with the locking groove 25. The gripper 21 may comprise an electrical actuator EA for the selection between the idle mode and active mode. The electrical actuator EA may increase and decrease size of the opening 23 and may be connected to an electrical supply ES and may be controlled under control of a control unit CU. The gripper 21 may comprise one or more movable gripping jaws or elements which define the size of the opening 23.

The rescue rope 13 can be at first pulled by hand until the counterpart 22 meets the gripper 21 and locks therein. Thereafter, the actual rescue movement of the elevator car 3 is executed by means of the pulling device 16 of the rescue system 12.

Implementation of the disclosed solution and embodiments are not limited to the exemplary elevator disclosed in the Figures. The solution can be used when executing maintenance for any type of elevator e.g., an elevator with no pit or low pit, an elevator comprising a machine room or lacking a machine room, an elevator comprising a counterweight or lacking a counterweight. Thus, the disclosed solution can be implemented in a versatile manner in buildings with low pit.

The drawings and the related description are only intended to illustrate the idea of the invention. In its details, the invention may vary within the scope of the claims.

1. A rescue system of an elevator for moving an elevator car vertically inside a shaft of the elevator in rescue operation;
the rescue system comprising:
at least one rescue rope connectable to an elevator car and being a separate element relative to a suspension rope of the elevator car; and
at least one pulling device generating pulling force and being connectable removably to the rescue rope for directing moving force to the elevator car by means of the rescue rope;
wherein
the rescue system further comprises at least one first diverting pulley mounted at a top part of the shaft and at least one second diverting pulley mounted at a bottom part of the shaft;
the rescue rope is configured to be conveyed via the mentioned first and second diverting pulleys thereby forming a loop configuration inside which the first and second diverting pulleys are located.

2. The rescue system as claimed in claim 1, wherein
one end of the rescue rope is connected to a top part of the elevator car and a second end of the rescue rope is connected to a bottom part of the elevator car.

3. The rescue system as claimed in claim 1, wherein
the rescue rope is selectively connectable to the elevator car.

4. The rescue system as claimed in claim 3, wherein
the elevator car is provided with a gripper;
the rescue rope is provided with a counterpart;
the gripper is selectively lockable and unlockable to the counterpart for coupling the rescue rope and the elevator car together.

5. The rescue system as claimed in claim 4, wherein
the gripper is a remotely controlled device whereby it is switchable between a connecting mode and an idle mode.

6. The rescue system as claimed in claim 1, wherein
the rescue rope passes the elevator car in a space between inner side surfaces of the shaft and outer sides surfaces of the elevator car.

7. The rescue system as claimed in claim 1, wherein
the separate pulling device is a pulling winch.

8. The rescue system as claimed in claim 1, wherein
the rescue system is provided with at least one safety switch being in connection with a control system of the rescue system and is configured to switch of electrical circuit of a drive system of the elevator in response to activation of the rescue control system.

9. An elevator comprising:
an elevator shaft;
an elevator car supported vertically movably inside the elevator shaft;
a hoisting machinery and suspension elements for moving and supporting the elevator car;
several landings;
at least one control unit (CU) for controlling operation of the elevator;
the elevator further comprises a rescue system provided with a rescue rope connectable to an elevator car and being a separate element relative to a suspension rope of the elevator car whereby a pulling device generating pulling force is connectable removably to the rescue rope for directing moving force to the elevator car by means of the rescue rope;
wherein the rescue system is in accordance with

1. and comprises at least one first diverting pulley mounted at a top part of the shaft and at least one second diverting pulley mounted at a bottom part of the shaft;
the rescue rope is configured to be conveyed via the mentioned first and second diverting pulleys thereby forming a loop configuration inside which the first and second diverting pulleys are located.

10. A method for moving an elevator car vertically inside a shaft of the elevator in a rescue operation wherein passengers are rescued out of the elevator car;
and wherein the method comprises:
connecting a separate pulling device removably to a rescue rope coupled to the elevator car and directing generated pulling force to the elevator car by means of the rescue rope and the pulling device during the rescue operation for moving the elevator car in downward direction towards a landing being nearest to a current vertical position of the elevator car;
characterized by
conveying the rescue rope via diverting pulleys mounted to structures of the shaft and directing the pulling force to the elevator car by moving the rescue rope via the diverting pulleys by means of the pulling device.

11. The method as claimed in claim 10, characterized by
allowing the elevator car to move freely in relation to the rescue rope during the normal operation of the elevator and coupling the rescue rope remotely to the elevator car only for the duration of the rescue operation.

12. The method as claimed in claim 10, characterized by
connecting the pulling device between the rescue rope and a structure of a floor of a landing.

13. The method as claimed in claim 10, characterized by
opening a rescue door of the shaft only partly and connecting the pulling device to the rescue rope through a narrow gap formed by the limited opening of the rescue door.

14. The method as claimed in claim 10, characterized by
connecting the elevator out of a normal operation mode to a rescue mode prior initiating moving measures of the rescue operation, whereby a normal drive mechanism of the elevator is switched out in the selected rescue mode.
